(19) United States
(12) Patent Application Publication
(10) Pub. No.: US 2009/0325592 A1
(43) Pub. Date: Dec. 31, 2009

(54) APPARATUS AND METHOD FOR DETERMINING A POSITION OF A COMPACT BASE STATION BY USING USER SUPPLIED LOCATION INFORMATION IN A BROADBAND WIRELESS COMMUNICATION SYSTEM

(75) Inventors: Byoung-Gi JANG, Suwon-si (KR); Hyon-Goo KANG, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/106,022

(22) Filed: Apr. 18, 2008

(30) Foreign Application Priority Data
Apr. 23, 2007 (KR) 2007-0039333

(51) Int. Cl. H04W 64/00

(52) U.S. Cl. 455/456.1

(57) ABSTRACT

An apparatus and method for determining a position of a compact Base Station (BS) by using user supplied location information in a broadband wireless communication system are provided. The method includes receiving a Global Positioning System (GPS) signal using a GPS receiver, receiving location information supplied by a user, comparing a strength of the GPS signal with a threshold, if the strength of the GPS signal is greater than the threshold, obtaining position information of the BS using the GPS signal, and if the strength to the GPS signal is less than or equal to the threshold, obtaining the position information of the BS using the location information.

### PRIORITY

This application claims the benefit under 35 U.S.C. § 119(a) of a Korean patent application filed in the Korean Intellectual Property Office on Apr. 23, 2007 and assigned Serial No. 2007-39333, the entire disclosure of which is hereby incorporated by reference.

### BACKGROUND OF THE INVENTION

1. Field of the Invention

The present invention relates to an apparatus and method for determining a position of a compact Base Station (BS) by using user supplied location information in a broadband wireless communication system. More particularly, the present invention relates to an apparatus and method for determining a position of a compact BS by using user supplied location information in an area with poor Global Positioning System (GPS) reception sensitivity.

2. Description of the Related Art

In broadband wireless communication systems, a compact Base Station (BS) may be used to complement a conventional BS. The compact BS is a home BS or a Small Office Home Office (SOHO) BS, which is installed in an area other than a service area of the conventional BS or in an area where service quality is unsatisfactory due to weak signal strength. Similar to the conventional BS, the compact BS provides a portable Internet service to a Mobile Station (MS). The compact BS can be characterized by low output, small capacity, and low cost, which are optimized for a small indoor environment (i.e., home or SOHO). The compact BS has to be able to interwork with the conventional BS, and a conventional MS has to be able to receive a service while switching between the compact BS and the conventional BS.

When the conventional BS and the compact BS are installed, the conventional BS and the compact BS should know their own position information (i.e., latitude, longitude, altitude, etc.) as well as their neighbor BSs' position information and also should know configuration (i.e., environment) information. The conventional BS may use a Global Positioning System (GPS) receiver to obtain position information of the conventional BS. When located inside a building surrounded by structures, below an overpass, or inside a tunnel, the GPS receiver may experience performance deterioration, which leads to errors in the position information. Therefore, when the BS is installed inside the building, it is difficult to obtain correct position information from the GPS receiver.

The errors in the position information may also occur because of an arrangement of the GPS satellites. The GPS receiver measures an exact time and distance by using three or more satellites, and then calculates a current position by using the three or more distances according to navigation based on trigonometry. As a result, the errors in the position information occur for certain positions of the satellites relative to the GPS receiver. The erroneous position information may lead to an incorrect initialization of the BS, thereby deteriorating system performance. In other words, when the erroneous position information is used without correction in the configuration and setting of the BS, this may result in errors such as wrong cell planning, and thus service quality may deteriorate.

Dilution Of Precision (DOP) is used as an index indicating reliability of a positioning result based on geometrical distribution between the satellite and the GPS receiver. When the DOP has a small value, errors are less significant, which shows that the position result is similar to an actual value. The DOP can be classified into five categories.
1) Geometrical DOP (GDOP): positioning errors depending on arrangement of satellites
2) Position DOP (PDOP): 3-dimensional positioning errors
3) Time DOP (TDOP): temporal positioning errors
4) Horizontal DOP (HDOP): horizontal 2-dimensional positioning errors
5) Vertical DOP (VDOP): altitudinal positioning errors

A hybrid method (e.g., a method used in conventional car navigation systems) which combines a GPS method and a sensor-assisted dead-reckoning navigation method is used to obtain position information of a moving device. In other words, the GPS method is used to obtain the position information in an area with good GPS reception sensitivity, and the dead-reckoning navigation method is used to obtain the position information in other areas. However, when a BS has a low mobility and thus exists around one location, it is difficult to complement a position of the BS. That is, the dead-reckoning navigation method cannot be used in this case.

Accordingly, there is a need for a method of obtaining correct position information of a device, such as the BS having a low mobility, in an area with poor GPS reception sensitivity.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for determining a position of a compact Base Station (BS) by using user supplied location information in a broadband wireless communication system.

Another aspect of the present invention is to provide an apparatus and method for determining a position of a compact BS using user supplied location information in an area with poor Global Positioning System (GPS) reception sensitivity in a broadband wireless communication system.

Another aspect of the present invention is to provide an apparatus and method in which position information is obtained using a GPS signal when a compact BS is located in an area with sufficient GPS reception sensitivity and in which position information is obtained using user supplied location information when the compact BS is located in an area with poor GPS reception sensitivity in a broadband wireless communication system.

In accordance with an aspect of the present invention, a method of obtaining position information of a BS in a broadband wireless communication system is provided. The method includes receiving a GPS signal using a GPS receiver, receiving location information supplied by a user, comparing a strength of the GPS signal with a threshold, if the strength of the GPS signal is greater than the threshold, obtaining position information of the BS using the GPS signal, and if the strength to the GPS signal is less than or equal to the threshold, obtaining the position information of the BS using the location information.

In accordance with another aspect of the present invention, an apparatus for obtaining position information of a BS in a broadband wireless communication system is provided. The apparatus includes a GPS receiver for receiving a GPS signal, an input unit for receiving location information supplied by a user, and a position information obtaining unit for comparing a strength of the received GPS signal with a threshold, for obtaining position information of the BS using the GPS signal if the strength of the GPS signal is greater than the threshold, and for obtaining the position information of the BS using the received location information if the strength to the GPS signal is less than or equal to the threshold.

In accordance with another aspect of the present invention, a method of obtaining position information of a BS in a broadband wireless communication system is provided. The method includes receiving location information supplied by a user, obtaining position information of the BS using the location information, and transmitting the obtained position information to a BS management server.

In accordance with another aspect of the present invention, an apparatus for determining a position of a BS in a broadband wireless communication system is provided. The apparatus includes the BS for obtaining position information of the BS using location information after receiving the location information from a user, and for transmitting the obtained position information to a BS management server, and the BS management server for determining a value which is set for the BS using the position information and for transmitting the value to the BS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 illustrates a network configuration of a broadband wireless communication system according to an exemplary embodiment of the present invention;

FIG. 2 is a block diagram illustrating elements of a compact Base Station (BS) in a broadband wireless communication system according to an exemplary embodiment of the present invention; and

FIG. 3 is a flowchart illustrating a method of determining a position of a compact BS in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions or constructions are omitted for clarity and conciseness.

Hereinafter, an apparatus and method for determining a position of a compact Base Station (BS) by using user supplied location information in a broadband wireless communication system will be described. Specifically, in the broadband wireless communication system of the exemplary embodiments of the present invention, correct position information (i.e., latitude, longitude, altitude, etc.) can be obtained by using a Global Positioning System (GPS) signal when the compact BS is located in an area with sufficient GPS reception sensitivity and by using user supplied location information when the compact BS is located in an area with poor GPS reception sensitivity. As such, by obtaining the correct position information by using the GPS signal and the user supplied location information, the compact BS can be configured and set easily and conveniently.

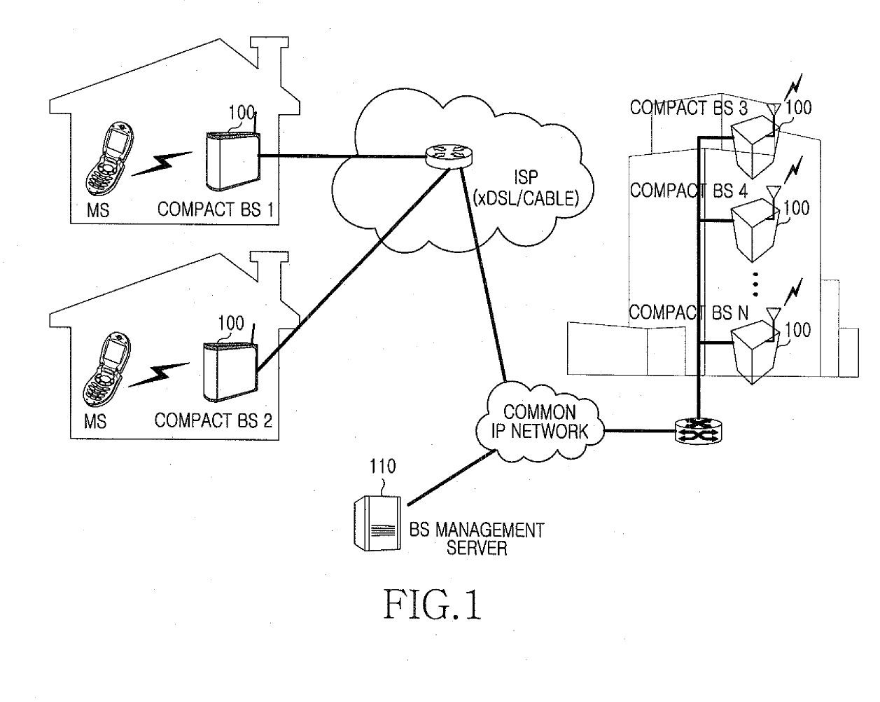

FIG. 1 illustrates a network configuration of a broadband wireless communication system according to an exemplary embodiment of the present invention.

Referring to FIG. 1, the broadband wireless communication system includes up to ‘N’ compact BSs 100 and a BS management server 110. Hereafter, a single compact BS 100 of the up to ‘N’ compact BSs 100 will be referred to. However, the description of the single compact BS 100 is equally applicable to any of the up to ‘N’ compact BSs 100.

The compact BS 100 performs system initialization when power is supplied and the BS 100 is turned on. Thereafter, the compact BS 100 obtains position information and then performs channel selection. In particular, according to the exemplary embodiment of the present invention, the compact BS 100 obtains the position information by using a GPS signal when located in an area with sufficient GPS reception sensitivity, and obtain the position information by using user supplied location information when located in an area with poor GPS reception sensitivity. When obtained by using the user supplied location information, the position information may be obtained in such as manner that the compact BS 100 transmits a position information request message including the user supplied location information to a database (not shown) and receives a position information response message including position information mapped to the user supplied location information from the database (not shown). The channel selection is performed to determine an optimal frequency, an optimal transmission power, and the like for cell planning when the BS is installed. In the channel selection, the compact BS 100 may transmit the obtained position information to the BS management server 110 and receive values (i.e., a frequency, a transmission power, etc.), which are set for the BS to minimize interference with a neighbor cell and maximize a service capacity, from the BS management server 110.

The BS management server 110 supports system settings (e.g., Internet Protocol (IP) settings of BSs, image downloading, etc.), and also monitors and manages states of the BSs which are currently operating. In particular, upon receiving the position information from the compact BS 100, the BS management server 110 recognizes a frequency and transmission power of a neighbor BS of the compact BS 100 by using the position information. Thereafter, the BS management server 110 determines the aforementioned values set for the BS, and then transmits the determined values to the compact BS 100.

The database (not shown) has a mapping table for mapping location information and conversion position information (e.g., latitude, longitude, etc.). Upon receiving the position information request message including the user supplied location information from the compact BS 100, the database searches for position information mapped to the user supplied location information (i.e., address, landmarks, or the like) and transmits the position information response message including the determined position information to the compact BS 100. Although it has been described in exemplary embodiment of the present invention that the database (not shown) is included in the BS management server 110 as an example, the database (not shown) may be implemented separately from the BS management server 110.

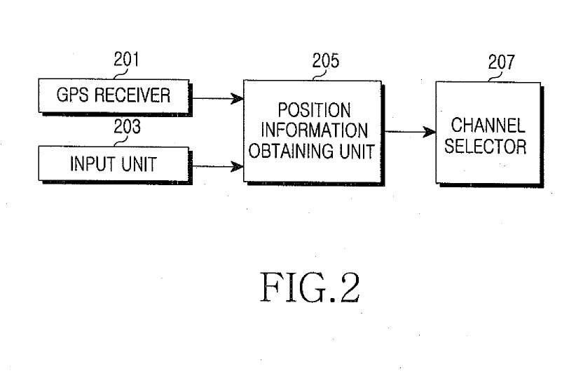

FIG. 2 is a block diagram illustrating elements of a compact BS in a broadband wireless communication system according to an exemplary embodiment of the present invention.

Referring to FIG. 2, the compact BS includes a GPS receiver 201, a input unit 203, a position information obtaining unit 205, and a channel selector 207.

The GPS receiver 201 receives a GPS signal and outputs the GPS signal to the position information obtaining unit 205.

The input unit 203 receives location information from a user and outputs the location information to the position information obtaining unit 205. The location information is received from the user in various ways. For example, the location information may be directly received from the user, or may be automatically received from a BS management server when powered on.

The position information obtaining unit 205 compares a strength of the received GPS signal with a threshold. If the strength of the GPS signal is greater than the threshold, position information of the BS is obtained by using the GPS signal. Otherwise, if the strength of the GPS signal is less than or equal to the threshold, the position information of the BS is obtained by using the received location information. In particular, according to an exemplary embodiment of the present invention, a method is provided in which correct position information is obtained by using Horizontal Dilution of Precision (HDOP) and Vertical Dilution of Precision (VDOP) of the GPS signal when the strength of the GPS signal is greater than the threshold. For this, the position information obtaining unit 205 calculates the HDOP of the GPS signal, and determines whether the calculation result is less than a threshold for the HDOP. If the HDOP of the GPS signal is less than the threshold, horizontal position information is obtained by using the GPS signal. Otherwise, if the HDOP of the GPS signal is greater than or equal to the threshold, the horizontal position information is obtained by using the location information. Further, the position information obtaining unit 205 calculates the VDOP of the GPS signal, and determines whether the calculation result is less than a threshold for the VDOP. If the VDOP of the GPS signal is less then the threshold, vertical position information is obtained by using the GPS signal. Otherwise, if the VDOP of the GPS signal is greater than or equal to the threshold, the vertical position information is obtained by using the location information. Thereafter, the position information obtaining unit 205 outputs the obtained position information to the channel selector 207.

The channel selector 207 performs channel selection by using the obtained position information.

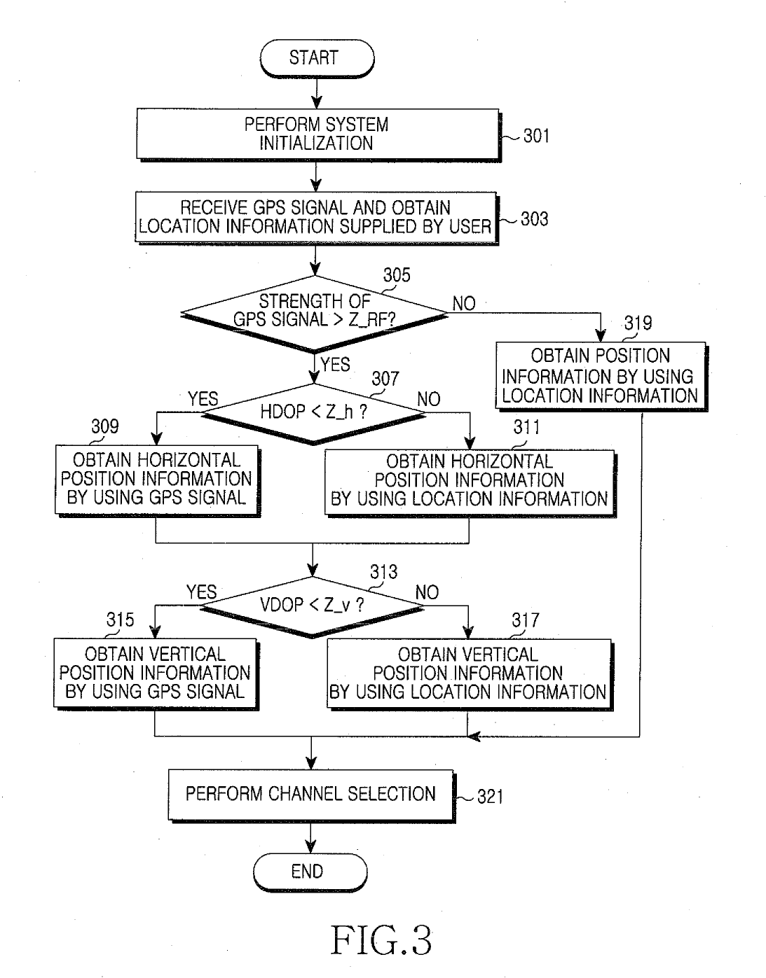

FIG. 3 is a flowchart illustrating a method of determining a position of a compact BS in a broadband wireless communication system according to an exemplary embodiment of the present invention.

Referring to FIG. 3, the BS performs system initialization when power is supplied and the BS is turned on in step 301. That is, an operation, such as IP setting and image downloading, is performed.

In step 303, the BS receives a GPS signal by using a GPS receiver to obtain position information (i.e., latitude, longitude, altitude, etc.) of the BS, and stores location information supplied by a user in a buffer. The location information can be supplied from the user in various ways. For example, the user may register the location information of the compact BS at a shop where the user purchases the compact BS. In this case, the location information of the compact BS may be stored in a database included in a BS management server so that the compact BS can automatically receive the location information from the BS management server when the compact BS is turned on. When this method is used, there is an advantage in that all compact BSs can be managed centrally. In addition to this method, various methods can be used, for example, a method in which the location information is registered online and a method in which the location information is directly input from the user to the BS.

In step 305, the BS determines whether a strength of the received GPS signal is greater than a threshold Z_RF for the strength of the GPS signal. Herein, the threshold Z_RF is an optimal value obtained through experimentation. If the strength of the GPS signal is less than or equal to the threshold Z_RF, the BS determines that a magnitude of the GPS signal is not sufficient. Then, in step 319, the BS obtains position information by using the location information supplied by the user, and proceeding to step 321, the BS performs channel selection.

Otherwise, if the strength of the GPS signal is greater than the threshold Z_RF, the BS determines that the magnitude of the GPS signal is sufficient. Then, through steps 307 to 317, the BS detects a cause of errors in the GPS signal and obtains the position information. The steps 307 to 317 are performed to determine reception sensitivity of the GPS signal by using DOP. It will be assumed in the exemplary embodiment of the present invention that HDOP and VDOP, which are respectively used as horizontal and altitudinal positioning errors, are used as an example.

Specifically, in step 307, the BS calculates the HDOP of the GPS signal, and determines whether the calculation result is less than a threshold Z_h. The threshold Z_h is a threshold for the HDOP, and is a preset optimal value. The lower the HDOP, the higher the probability that the position information is correct. In general, it is determined that the DOP of 3 or less is excellent and it is also determined that the DOP of 5 or more leads to significant errors. If the HDOP of the GPS signal is less than the threshold Z_h, the BS determines that the reception sensitivity of the GPS signal is good, that is, an error of the GPS signal is within an acceptable error range. Then, in step 309, the BS obtains horizontal position information (e.g., latitude and longitude) by using the GPS signal instead of the location information. Otherwise, if the HDOP of the GPS signal is greater than or equal to the threshold Z_h, the BS obtains the horizontal position information by using the location information supplied by the user instead of the GPS signal in step 311.

To obtain the horizontal position information by using the location information supplied by the user, a position information request message including a Base Station IDentifier (BSID) and location information has to be transmitted to the database. The database has a mapping table for mapping the location information and conversion position information (e.g., latitude, longitude, etc.). Further, the database converts the location information into a form of position information, and transmits a position information response message including the conversion position information to the BS. Accordingly, the BS obtains the horizontal position information, and stores the obtained horizontal position information.

To obtain altitude information after obtaining the horizontal position information (e.g., latitude and longitude), the BS calculates the VDOP of the GPS signal and determines whether the calculation result is less than a threshold Z_v in step 313. The threshold Z_v is a threshold for the VDOP, and is a preset optimal value. If the VDOP of the GPS signal is less than the threshold Z_v, in the same manner as that used to obtain the horizontal position information, the BS obtains vertical position information (e.g., altitude) by using the GPS signal instead of the location information supplied by the user in step 315. Otherwise, if the VDOP of the GPS signal is greater than or equal to the threshold Z_v, the BS obtains the vertical position information by using the location information supplied by the user instead of the GPS signal in step 317.

Similarly to the aforementioned steps 307 to 317, after obtaining the correct position information by using the HDOP and VDOP of the GPS signal, the BS performs channel selection by using the obtained position information in step 321. The channel selection is performed to determine an optimal frequency, an optimal transmission power, and the like for cell planning when the BS is installed. In the channel selection, the BS transmits the obtained position information to the BS management server, and the BS management server recognizes a frequency and a transmission power of a neighbor BS by using the position information. Thereafter, the BS management server determines values (i.e., a frequency, a transmission power, etc.), which are set for the BS to minimize interference with a neighbor cell and maximize a service capacity, and then transmits the determined values to the BS. Thereafter, the BS starts to provide a service according to a result of the channel selection, and the procedure of FIG. 3 ends.

According to exemplary embodiments of the present invention, in a broadband wireless communication system, position information is obtained by using a GPS signal when a compact BS is located in an area with excellent GPS reception sensitivity, and the position information is obtained by using location information supplied by a user when the compact BS is located in an area with poor GPS reception sensitivity. Therefore, correct position information can be obtained, and the compact BS can be configured and set easily and conveniently. In particular, there is an advantage in that correct position information can be obtained when positional complementation is difficult because of relatively poor reception sensitivity of the GPS signal and a low mobility. In addition, an optimal threshold is determined to use further correct position information by selecting either the GPS signal or the user supplied location information. Therefore, the BS can be properly initialized by using the correct position information, and system performance can be optimized in consideration of a neighbor cell.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A method of obtaining position information of a Base Station (BS) in a wireless communication system, the method comprising:
receiving a Global Positioning System (GPS) signal using a GPS receiver;
receiving location information supplied by a user;
comparing a strength of the GPS signal with a threshold;
if the strength of the GPS signal is greater than the threshold, obtaining position information of the BS using the GPS signal; and
if the strength to the GPS signal is less than or equal to the threshold, obtaining the position information of the BS using the location information.

2. The method of claim 1, further comprising performing system initialization when the BS is powered on.

3. The method of claim 1, wherein the location information is at least one of directly received from the user and received from a BS management server.

4. The method of claim 1, further comprising performing channel selection by using the obtained position information.

5. The method of claim 1, wherein the obtaining of the position information of the BS by using the received GPS signal comprises:
calculating a Horizontal Dilution Of Precision (HDOP) of the GPS signal and determining whether the calculation result is less than a threshold for the HDOP;
if the HDOP of the GPS signal is less than the threshold, obtaining horizontal position information by using the GPS signal; and
if the HDOP of the GPS signal is greater than or equal to the threshold, obtaining the horizontal position information by using the location information.

6. The method of claim 5, further comprising:
calculating a Vertical Dilution Of Precision (VDOP) of the GPS signal and determining whether the calculation result is less then a threshold for the VDOP;
if the VDOP of the GPS signal is less than the threshold, obtaining vertical position information by using the GPS signal; and
if the VDOP of the GPS signal is greater than or equal to the threshold, obtaining the vertical position information by using the location information.

7. The method of claim 1, wherein the obtaining the position information by using the location information comprises:
transmitting a position information request message, which includes a BS identifier and information corresponding to the location information, to a database; and
receiving a position information response message including position information mapped to the location information from the database.

8. An apparatus for obtaining position information of a Base Station (BS) in a wireless communication system, the apparatus comprising:
a Global Positioning System (GPS) receiver for receiving a GPS signal;
an input unit for receiving location information supplied by a user; and
a position information obtaining unit for comparing a strength of the received GPS signal with a threshold, for obtaining position information of the BS using the GPS signal if the strength of the GPS signal is greater than the threshold, and for obtaining the position information of the BS using the received location information if the strength to the GPS signal is less than or equal to the threshold.

9. The apparatus of claim 8, wherein the input unit at least one of directly receives the location information from the user and receives the location information from a BS management server.

10. The apparatus of claim 8, wherein the position information obtaining unit comprises:
means for calculating Horizontal Dilution Of Precision (HDOP) of the GPS signal and for determining whether the calculation result is less than a threshold for the HDOP;
means for obtaining horizontal position information by using the GPS signal if the HDOP of the GPS signal is less than the threshold; and
means for obtaining the horizontal position information by using the location information if the HDOP of the GPS signal is greater than or equal to the threshold.

11. The apparatus of claim 8, wherein the position information obtaining unit comprises:
means for calculating Vertical Dilution Of Precision (VDOP) of the GPS signal and for determining whether the calculation result is less then a threshold for the VDOP;
means for obtaining vertical position information by using the GPS signal if the VDOP of the GPS signal is less than the threshold; and
means for obtaining the vertical position information by using the location information if the VDOP of the GPS signal is greater than or equal to the threshold.

12. The apparatus of claim 8, wherein the position information obtaining unit comprises:
means for transmitting a position information request message, which includes a BS identifier and information on the location information, to a database; and
means for obtaining position information by receiving a position information response message including position information mapped to the location information from the database.

13. The apparatus of claim 8, further comprising a channel selector for performing channel selection by using the obtained position information.

14. The apparatus of claim 13, wherein the channel selector comprises:
means for transmitting the obtained position information to the BS management server; and
means for receiving a value, which is set for the BS and is determined by using the position information, from the BS management server.

15. The apparatus of claim 14, wherein the value set for the BS comprises at least one of a frequency and a transmission power.

16. A method of obtaining position information of a Base Station (BS) in a wireless communication system, the method comprising:
receiving location information supplied by a user;
obtaining position information of the BS using the location information; and
transmitting the obtained position information to a BS management server.

17. The method of claim 16, further comprising receiving a value which is set for the BS from the BS management server.

18. The method of claim 17, wherein the value set for the BS comprises at least one of a frequency and a transmission power.

19. The method of claim 16, wherein the location information is at least one of directly received from the user and received from the BS management server.

20. The method of claim 16, wherein the obtaining of the position information comprises:
transmitting a position information request message, which includes a BS identifier and information on the location information, to a database; and
receiving a position information response message including position information mapped to the location information from the database.

21. The method of claim 16, further comprising performing system initialization when power is on.

22. An apparatus for determining a position of a Base Station (BS) in a wireless communication system, the apparatus comprising:
the BS for obtaining position information of the BS using location information after receiving the location information from a user, and for transmitting the obtained position information to a BS management server; and
the BS management server for determining a value which is set for the BS using the position information and for transmitting the value to the BS.

23. The apparatus of claim 22, wherein the value set for the BS comprises at least one of a frequency and a transmission power.

24. The apparatus of claim 22, further comprising
a database for receiving a position information request message from the BS, for searching for position information mapped to the location information, and for transmitting a position information response message including the position information to the BS,
wherein the BS transmits the position information request message, which includes a BS identifier and information corresponding to the location information, to the database and obtains the position information from the database.

25. The apparatus of claim 22, wherein the BS at least one of directly receives the location information from the user and receives the location information from the BS management server.
